(19) United States
(12) Patent Application Publication
(10) Pub. No.: US 2023/0237417 A1
(43) Pub. Date: Jul. 27, 2023

(54) ASSISTANT FOR EFFECTIVE ENGAGEMENT OF EMPLOYEES

(71) Applicant: Dell Products L.P., Round Rock, TX (US)

(72) Inventors: Dhilip Kumar, Bangalore (IN); Sujit Kumar Sahoo, Bangalore (IN)

(73) Assignee: Dell Products L.P., Round Rock, TX (US)

(21) Appl. No.: 17/648,578

(22) Filed: Jan. 21, 2022

(51) Int. Cl. G06Q 10/06

(52) U.S. Cl. CPC G06Q 10/06398

(57) ABSTRACT

A method comprising: generating first sentiment identifier of a user, the first sentiment identifier of the user being a text sentiment identifier; generating a second sentiment identifier of the user, the second sentiment identifier including one of a voice sentiment identifier of the user and an image sentiment identifier of the user, the image sentiment identifier being an indication of an emotional state of the user that is manifested in a facial expression of the user during the telephone call; generating a composite signature of the user based on the first sentiment identifier and the second sentiment identifier; and classifying the composite signature of the user into one of a plurality of categories.

### BACKGROUND

A virtual assistant is software that can perform tasks or services for a user. A virtual assistant may be either a standalone software application that is running on the user's device or it may be integrated in other software. Virtual assistants are commonly used on computers and other devices to perform functions, such as communicating with the user, retrieving information, and playing media.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

According to aspects of the disclosure, a method is provided comprising: generating first sentiment identifier of a user, the first sentiment identifier of the user being a text sentiment identifier, the text sentiment identifier being indicative of an emotional state that is manifested in one or more of a telephone call in which the user participated, an email that is authored by the user, and/or a message exchange in which the user participated; generating a second sentiment identifier of the user, the second sentiment identifier including one of a voice sentiment identifier of the user and an image sentiment identifier of the user, the image sentiment identifier being an indication of an emotional state of the user that is manifested in a facial expression of the user during the telephone call, the voice sentiment identifier being an indication of an emotional state of the user that is manifested in a tone of voice of the user during the telephone call; generating a composite signature of the user based on the first sentiment identifier and the second sentiment identifier; and classifying the composite signature of the user into one of a plurality of categories, each of the plurality of categories being associated with at least one of: (i) different levels of workplace fatigue and/or (ii) different actions for reducing workplace fatigue.

According to aspects of the disclosure, a system is provided, comprising: a memory; and at least one processor operatively coupled to the memory, the at least one processor being configured to perform the operations of: generating first sentiment identifier of a user, the first sentiment identifier of the user being a text sentiment identifier, the text sentiment identifier being indicative of an emotional state that is manifested in one or more of a telephone call in which the user participated, an email that is authored by the user, and/or a message exchange in which the user participated; generating a second sentiment identifier of the user, the second sentiment identifier including one of a voice sentiment identifier of the user and an image sentiment identifier of the user, the image sentiment identifier being an indication of an emotional state of the user that is manifested in a facial expression of the user during the telephone call, the voice sentiment identifier being an indication of an emotional state of the user that is manifested in a tone of voice of the user during the telephone call; generating a composite signature of the user based on the first sentiment identifier and the second sentiment identifier; and classifying the composite signature of the user into one of a plurality of categories, each of the plurality of categories being associated with at least one of: (i) different levels of workplace fatigue and/or (ii) different actions for reducing workplace fatigue.

According to aspects of the disclosure, a non-transitory computer-readable medium is provided that stores one or more processor-executable instructions, which, when executed by at least one processor, cause the at least one processor to perform the operations of: generating first sentiment identifier of a user, the first sentiment identifier of the user being a text sentiment identifier, the text sentiment identifier being indicative of an emotional state that is manifested in one or more of a telephone call in which the user participated, an email that is authored by the user, and/or a message exchange in which the user participated; generating a second sentiment identifier of the user, the second sentiment identifier including one of a voice sentiment identifier of the user and an image sentiment identifier of the user, the image sentiment identifier being an indication of an emotional state of the user that is manifested in a facial expression of the user during the telephone call, the voice sentiment identifier being an indication of an emotional state of the user that is manifested in a tone of voice of the user during the telephone call; generating a composite signature of the user based on the first sentiment identifier and the second sentiment identifier; and classifying the composite signature of the user into one of a plurality of categories, each of the plurality of categories being associated with at least one of: (i) different levels of workplace fatigue and/or (ii) different actions for reducing workplace fatigue.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a system, according to aspects of the disclosure;

FIG. 2 is a diagram of an employee monitoring system, according to aspects of the disclosure;

FIG. 3 is a diagram of an example of an expert repository, according to aspects of the disclosure;

FIG. 4 is a diagram of an example of a graph, according to aspects of the disclosure;

FIG. 5A is a diagram of an example of a recommendation engine, according to aspects of the disclosure;

FIG. 5B is a diagram of an example of a recommendation engine, according to aspects of the disclosure; and

FIG. 6 is a flowchart of an example of a process, according to aspects of the disclosure.

### DETAILED DESCRIPTION

Recently, remote work has been on the rise in many organizations, with a peak of 62% of employed US adults working part or full time from their homes. However, the increase in remote work has also led to an increase in the rate of burnout experienced by employees, with more than two-thirds, or 69%, of employees experiencing burnout symptoms while working from home.

In a remote work context, it is challenging for leaders to detect changes in employees' disposition, which might be indicative of burnout. This is because, in the virtual world, leaders are unable to read and connect with the body language of employees or closely observe their facial expressions or tone of voice.

According to the present disclosure, a special-purpose virtual assistant is provided that detects features of an employee's facial expression, tone of voice, or sentiment, which might be indicative of burnout. The special-purpose virtual assistant is herein referred to as an “employee monitoring system” and it may use artificial intelligence to monitor information that is transmitted by the employee over various communications channels, detect changes in employee disposition based on the information, and provide advice for engaging the employee when such changes are detected. Providing advice for engaging the employee may include identifying an engagement action, which if taken, may help reduce the levels of fatigue that are experienced by the employee. Such action may include emailing the employee, conducting an in-person meeting with the employee, or merely beginning to monitor the employee.

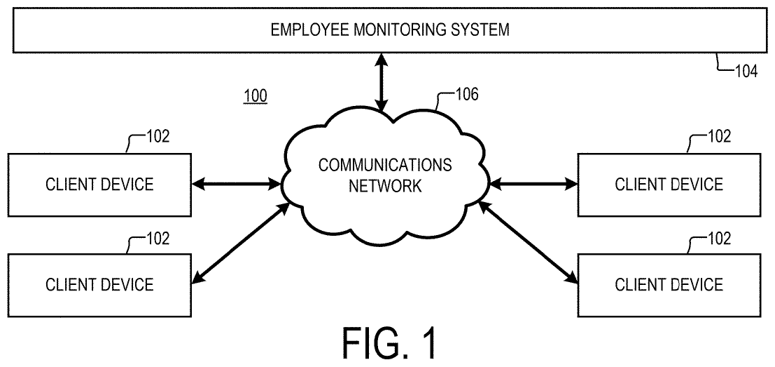

FIG. 1 is a diagram of an example of a system 100, according to aspects of the disclosure. As illustrated, the system 100 may include one or more computing devices 102 that are coupled to one another via a communications network 106. Each of the computing devices 102 may include a smartphone, a desktop computer, a laptop, and/or any other suitable type of computing device. Each of the computing devices 102 may be used by a respective user. The communications network 106 may include one or more of a local area network (LAN), a wide area network (WAN), the Internet, a 5G cellular network, and/or any other suitable type of communications network. Although in the example of FIG. 1 system 100 includes only four devices 102, it will be understood that in practice the system 100 may include a larger number of devices 102.

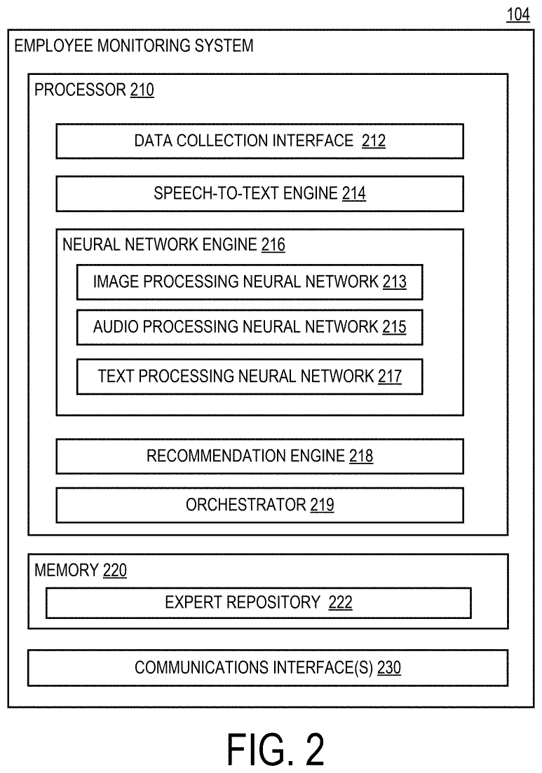

The system 100 may be part of the enterprise network of an organization. The users of the devices 102 may be employees of the organization. In this regard, the system 100 may include an employee monitoring system 104, which is configured to monitor communications that are exchanged by the users of the computing devices 102 (i.e., communications exchanged by the employees of the organization). Such communications may include voice communications, video communications, emails, text messages, and/or any other suitable type of communications. Based on the communications, the system 104 may identify users that are experiencing symptoms of fatigue or burnout. For any user who is found to be experiencing burnout or fatigue, the system 104 may recommend an engagement action. Such action may include emailing the employee, conducting a one-on-one meeting, and/or any other suitable action. The purpose of the engagement action may be to reduce the levels of fatigue experienced by the employee, find the root cause of the fatigue, and/or otherwise improve the productivity or morale of the employee. The operation of the system 104 is discussed further below with respect to FIGS. 2-6.

FIG. 2 is a diagram of an example of the employee monitoring system 104, according to aspects of the disclosure. The computing device may include a processor 210, a memory 220, and a communications interface 230. The processor 210 may include any of one or more general-purpose processors (e.g., x86 processors, RISC processors, ARM-based processors, etc.), one or more Field Programmable Gate Arrays (FPGAs), one or more application-specific circuits (ASICs), and/or any other suitable type of processing circuitry. The memory 220 may include any suitable type of volatile and/or non-volatile memory. In some implementations, the memory 220 may include one or more of a random-access memory (RAM), a dynamic random memory (DRAM), a flash memory, a hard drive (HD), a solid-state drive (SSD), a network accessible storage (NAS), and or any other suitable type of memory device. The communications interface 230 may include any suitable type of communications interface, such as one or more Ethernet adapters, one or more Wi-Fi adapters (e.g., 802.1414 adapters), and one or more Long-Term Evolution (LTE) adapters, for example.

The processor 210 may be configured to execute a data collection interface 212, a speech-to-text engine 214, a neural network engine 216, a recommendation engine 218, and an orchestrator 219. The memory 220 may be configured to store an expert repository 222. Although in the example of FIG. 2 the system 104 is depicted as an integrated system, it will be understood that alternative implementations are possible in which the system 104 is a distributed system comprising a plurality of computing devices that are coupled to one another via a communications network. It will be understood that the present disclosure is not limited to any specific implementation of the system 104.

The data collection interface 212 may include one or more APIs and/or webhooks for retrieving data that is transmitted over one or more communications channels by the users of devices 102. For example, the data collection interface 212 may be configured to receive (or obtain): (i) emails that are transmitted from the devices 102, (ii) recordings of telephone calls in which any of the devices 102 (or its user) participated, (ii) text messages that are transmitted by any of the devices 102 (or its user), and/or a record of any other suitable type of communication in which any of the devices 102 (or their users) participated. In some implementations, the data collection interface 212 may be configured to intercept telephone calls that are being conducted in the system 100. The data collection interface 212 may create recordings of such intercepted telephone calls or stream the intercepted data to the speech-to-text engine 214 for transcription.

As used herein, the term telephone call may refer to a voice call, a video call, a teleconference call, and/or any other suitable type of communication that involves a real-time transmission of voice and/or video. A telephone call recording may be voice-only or it may include both voice and video. Any of the telephone calls discussed through the application may be conducted using the public switched telephone network (PSTN), the Internet, a Voice-Over-IP (VoIP) network, a cellular network, and/or any other suitable type of communications network. In this regard, it will be understood that the term “telephone call” refers to any real-time voice or video communication. The “term message exchange” may refer to an online chat session, an exchange of SMS messages, a messenger app message, and/or an exchange of any other suitable type of message. The messages that are exchanged during a message exchange may include text only or they may include audio and/or video, as well. The term “message transcript”, as used herein may refer to a document (or object) that includes the text of one or more text messages (e.g., online chat messages, messaging app messages, SMS messages, etc.) that are transmitted by the user. Optionally, the text transcript may also include messages that are transmitted by a person with whom the user is engaged in a conversation.

The speech-to-text engine 214 may be configured to receive, from the interface 212, a recording of a telephone call in which a given one of the users of devices 102 has participated. The engine 214 may process the telephone call to generate a text transcript of the telephone call. After the text transcript is generated, the engine 214 may provide the text transcript to the neural network engine 216.

The neural network engine 216 may receive, from the interface 212, one or more of: (i) the text of one or more emails that are sent by the user of any of devices 102, (ii) the text of one or more messages that are sent by the user of any of devices 102 (e.g., a message transcript of the user), (iii) an audio recording of a telephone call in which any of the devices 102 (or its user) participated, and (iv) a video recording of a telephone call in which any of the devices 102 (or its user) participated. In addition, the neural network engine 216 may receive, from the speech-to-text engine 214, a text transcript of a telephone call in which the user of any of devices 102 participated. As used herein, the term “audio recording” refers to the audio track of the telephone call. Under this definition, both video files and audio files qualify as audio recordings.

For any given user (of one of devices 102), the neural network engine 216 may use any received content to generate an image signature, an audio signature, and a video signature. The image signature may be generated based on one or more images of the given user. The image signature may be generated based on one or more image frames that are part of a video recording of a telephone call (i.e., video call) in which the user participated. The audio signature may be generated based on an audio recording of a telephone call (e.g., either a video call or an audio call) in which the user participated. The text signature may be generated based on one or more of: (i) the text transcript of a telephone call in which the user participated, (ii) the transcript of an online chat session in which the given user participated, (iii) one or more emails that were sent to the user, and/or (iv) any other suitable type written content that is authored by the user.

The present disclosure is not limited to using any specific method for feature extraction to generate the audio, video, and text signatures. It will be understood that any technique that is known in the art could be used to generate those signatures. Furthermore, it will be understood that the neural network engine 216 may be configured to perform any necessary pre-processing on the contents to generate the audio, video, and text signatures. Such preprocessing may include dimension reduction, normalization, and/or and or any other suitable type of pre-processing.

In some implementations, the audio signature may be generated based only on audio that includes the speech of the user (and which lacks the speech of a party the user is conversing with). In some implementations, the video signature may be generated only based on one or more images of the user. Each of the images may be a headshot of the user or a video frame that contains an image of the user, which was recorded while the user was participating in a telephone call. However, alternative implementations are possible in which the images are shot from another angle and/or show the physical posture of the user. In some implementations, the text signature may be generated based on the transcript of the user's speech, while omitting the transcript of the speech of any far-end parties the user is conversing with. As another example, when it is generated based on the transcript of an online chat, the text signature may be generated only on content that is typed by the user, while omitting words that are typed by other chat session participants. In some implementations, any of the voice and video signatures may be generated based on speech/text that is produced by a far-end party. Stated succinctly, the present disclosure is not limited to using any specific content for generating the image, voice, and text signatures.

The neural network engine 216 may determine a video sentiment identifier of the user based on the video signature. The video sentiment identifier of the user may be any number, sting, or alphanumerical string that is indicative of a mood or emotions of the user that are manifested in the user's facial expression. For example, and without limitation, the video sentiment identifier of the user may indicate that the user is experiencing one of the following emotions: worry, anger, happiness, sadness, disgust, fear, surprise, contempt, and neutral emotion. It will be understood that the present disclosure is not limited to any specific implementation or format of the video sentiment identifier. For example, in some implementations, the video sentiment identifier may identify one or more feelings that are experienced by the user. Additionally or alternatively, in some implementations, the video sentiment identifier may identify the degree to which any of the identified feelings is being experienced by the user.

The neural network engine 216 may determine an audio sentiment identifier of the user based on the audio signature. The audio sentiment identifier of the user may be any number, sting, or alphanumerical string that is indicative of a mood or emotions of the user that are manifested in the user's tone of voice. For example, and without limitation, the audio sentiment identifier of the user may indicate that the user is experiencing one of the following emotions: worry, anger, happiness, sadness, disgust, fear, surprise, contempt, and neutral emotion. It will be understood that the present disclosure is not limited to any specific implementation or format of the audio sentiment identifier. For example, in some implementations, the audio sentiment identifier may identify one or more feelings that are experienced by the user. Additionally or alternatively, in some implementations, the audio sentiment identifier may identify the degree to which any of the identified feelings is being experienced by the user.

The neural network engine 216 may determine a text sentiment identifier of the user based on the text signature. The text sentiment identifier of the user may be any number, sting, or alphanumerical string that is indicative of a mood or emotions of the user that are manifested in one or more of: the transcript of a telephone call in which the user has participated, the transcript of a chat session in which the user has participated, one or more emails that were sent by the user, and/or any other text that is authored by the user. For example, and without limitation, the text sentiment identifier of the user may indicate that the user is experiencing one of the following emotions: worry, anger, happiness, sadness, disgust, fear, surprise, contempt, and neutral emotion. It will be understood that the present disclosure is not limited to any specific implementation or format of the text sentiment identifier. For example, in some implementations, the text sentiment identifier may identify one or more feelings that are experienced by the user. Additionally or alternatively, in some implementations, the text sentiment identifier may identify the degree to which any of the identified feelings is being experienced by the user.

The neural network engine 216 may implement a neural network 213. The neural network engine 216 may use the neural network 213 to calculate the video sentiment identifier. Specifically, the video sentiment identifier of the user may be determined by classifying the video signature of the user into one of a plurality of categories (e.g., which correspond to different emotional states, etc.). The neural network 213 may include any suitable type of image recognition network for detecting emotions (or sentiment contained in the facial expression of a person). According to the present example, the neural network 213 is a convolutional neural network (CNN). However, the present disclosure is not limited thereto. The neural network 213 may be trained using a supervised learning algorithm. The neural network 213 may be trained based on a training data set, which is generated based on communications that are exchanged in the system 100, and as such, it may reflect the manner in which different emotions are expressed by the organization's employees in their daily professional interactions. The labels associated with the training data set may correspond to different emotions, and they may be assigned manually.

The neural network engine 216 may implement a neural network 215. The neural network engine 216 may use the neural network 215 to calculate the audio sentiment identifier. Specifically, the audio sentiment identifier of the user may be determined by classifying the audio signature of the user into one of a plurality of categories (e.g., which correspond to different emotional states, etc.). The neural network 215 may include any suitable type of voice recognition network for detecting emotions (or sentiment contained in the tone of voice of a person). According to the present example, the neural network 215 is a convolutional neural network (CNN). However, the present disclosure is not limited thereto. The neural network 215 may be trained using a supervised learning algorithm. The neural network 215 may be trained based on a training data set, which is generated based on communications that are exchanged in the system 100, and as such, it may reflect the manner in which different emotions are expressed by the organization's employees in their daily professional interactions. The labels associated with the training data set may correspond to different emotions, and they may be assigned manually.

The neural network engine 216 may implement a neural network 217. The neural network engine 216 may use the neural network 217 to calculate the text sentiment identifier. Specifically, the text sentiment identifier of the user may be determined by classifying the text signature of the user into one of a plurality of categories (e.g., which correspond to different emotional states, etc.). The neural network 217 may include any suitable type of natural language processing network for detecting emotion (or sentiment contained in the verbal communications of a person). According to the present example, the neural network 217 is a feed-forward neural network. However, the present disclosure is not limited thereto. The neural network 217 may be trained using a supervised learning algorithm. The neural network 217 may be trained based on a training data set, which is generated based on communications that are exchanged in the system 100, and as such, it may reflect the manner in which different emotions are expressed by the organization's employees in their daily professional interactions. The labels associated with the training data set may correspond to different emotions, and they may be assigned manually.

The recommendation engine 218 may be configured to receive, from the neural network engine 216, one or more audio sentiment identifiers of a user, one or more video sentiment identifiers of the user, and one or more text sentiment identifiers of the user. The recommendation engine may generate a composite signature of the user based on the received sentiment identifiers. In one implementation, the composite signature may include (or encode): one text sentiment identifier of the user, one voice sentiment identifier of the user, and one image sentiment identifier of the user. In this implementation, the composite signature may identify the set of emotions that are communicated by the user, at the same time, in various verbal and non-verbal ways (e.g., facial expression, tone-of-voice, and speech). In another implementation, the composite signature may include (or encode) a plurality of voice sentiment identifiers of the user, a plurality of image sentiment identifiers of the user, and a plurality of voice sentiment identifiers of the user. In this implementation, the composite signature may identify the set of emotions that are communicated by the user over a period of time, and it may show how the user's emotions have changed over the period of time. In yet another implementation, the composite signature may include (or encode): (i) one or more voice sentiment identifiers of the user, (ii) one or more image sentiment identifiers of the user, and (iii) one or more text sentiment identifiers of the user. In some implementations, the composite signature may include (or encode) only two types of sentiment identifiers (e.g., only voice and text sentiment identifiers, only image and text sentiment identifiers, or only voice and image sentiment identifiers). The composite signature may be generated by concatenating different sentiment identifiers. However, it will be understood that the present disclosure is not limited to any specific method for encoding different types of sentiment identifiers into a composite signature. Furthermore, in some implementations, the term “composite signature” may refer to any collection of different types of identifiers.

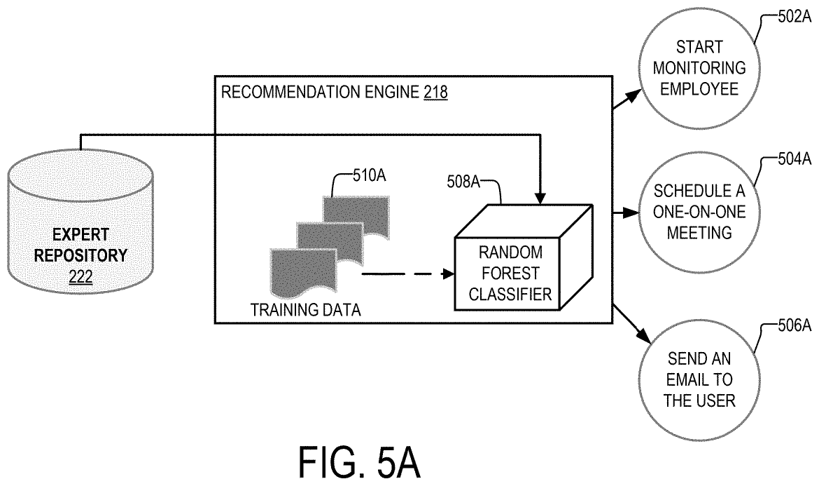

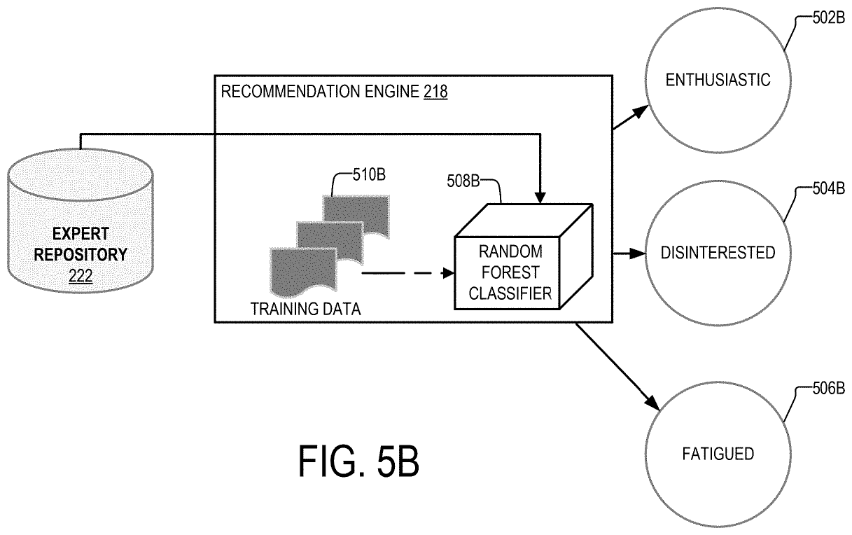

The recommendation engine 218 may be configured to classify the composite signature into one of a plurality of categories. In one implementation, each of the categories may correspond to a different state of the user (e.g., enthusiastic about work, disinterested in work, fatigued, etc.). In another implementation, each of the categories may correspond to a different engagement action that may be taken with respect to the user. Examples of engagement actions include “monitoring the user”, “conducting an in-person meeting with the user”, or “sending an email to the user.” The operation of the recommendation engine 218 is discussed further below with respect to FIGS. 5A-B.

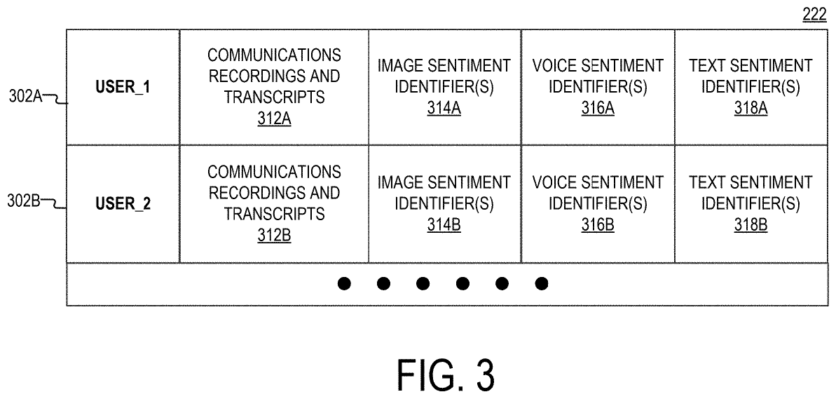

The orchestrator 219 may be a service or process that coordinates the execution of the data collection interface 212, the speech-to-text engine 214, and the neural network engine 216. The orchestrator 219 may also be configured to populate and maintain the expert repository 222. The expert repository 222 may include a plurality of records. Each record may correspond to a different user of the system 100. Each record may include: (i) one or more voice sentiment identifiers of the record's respective user; (ii) one or more image sentiment identifiers of the record's respective user; and (iii) one or more text sentiment identifiers of the record's respective user. Additionally or alternatively, in some implementations, each record may include: (i) one or more transcripts of telephone calls in which the record's respective user participated, (ii) one or more recordings of telephone calls in which the record's respective user participated, (iii) one or more emails that were sent by the user, (iv) one or more message transcripts of the user, etc. One possible implementation of the expert repository 222 is discussed further below with respect to FIG. 3.

FIG. 3 is a schematic diagram of the repository 222, according to one implementation. As illustrated, the repository 222 may include records 302A and 302B. Record 302A may correspond to a first user and record 302B may correspond to a second user. Record 302A may include four types of data: (i) records, recordings, and transcripts 312A, of communications in which the first user participated or which were authored by the first user, (ii) one or more image sentiment identifiers 314A for the first user that have been generated by the neural network 213 based on respective portions of the data 312A, (iii) one or more voice sentiment identifiers 316A for the first user that have been generated by the neural network 215 based on respective portions of the data 312A, and (iv) one or more voice sentiment identifiers 318A for the first user that have been generated by the neural network 217 based on respective portions of the data 312A. Record 302B may include four types of data: (i) records, recordings, and transcripts 312B of communications in which the second user participated or which were ordered by the user, (ii) one or more image sentiment identifiers 314B for the second user that have been generated by the neural network 213 based on respective portions of the data 312B, (iii) one or more voice sentiment identifiers 316B for the second user that have been generated by the neural network 215 based on respective portions of the data 312B, and (iv) one or more voice sentiment identifiers 318B for the second user that have been generated by the neural network 217 based on respective portions of the data 312B. Although FIG. 3 shows records of only two users, it will be understood that the repository 222 may include a different respective record for each of the users of the system 100 (shown in FIG. 1).

In some implementations, the system 104 may monitor (and/or intercept) communications that are transmitted by the users of the devices 102 and update the repository 222 to include data corresponding to any of the intercepted (or monitored) communications. In some implementations, the system 104 may periodically re-train the neural networks 213, 215, and 217, as new data becomes available.

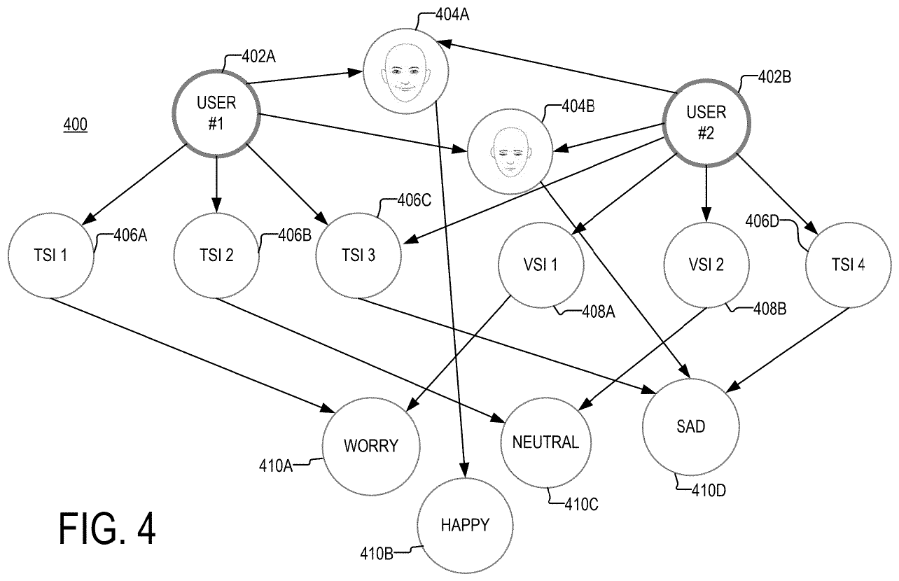

FIG. 4 is a graph 400 illustrating an example of relationships that may be represented by the repository 222. FIG. 4 illustrates that the repository 222 may be used to track what emotions were manifested, at different times, and in different types of communication of a user (e.g., verbal and non-verbal). FIG. 4 further illustrates that the repository 222 may be used to establish an emotional profile of the user in a particular time period.

In the example of FIG. 4, graph 400 includes nodes 402A-B, nodes 404A-B, nodes 406A-D, nodes 408A-B, and nodes 410A-D. Node 402A corresponds to the first user (associated with the record 302A of FIG. 3). Node 402B corresponds to the second user (associated with the record 302B of FIG. 3). Node 410A is associated with a “worried” emotional state. Node 410B is associated with a “happy” emotional state. Node 410C is associated with a “neutral” emotional state. Node 410D is associated with a “sad” emotional state. Node 404A corresponds to one or more image sentiment identifiers of the first user that are associated with a “happy” emotional state. Node 404B corresponds to one or more image sentiment identifiers of the first user that are associated with a “sad” emotional state and one or more image sentiment identifiers of the second user that are associated with the “sad” emotional state.

Node 406A corresponds to one or more text sentiment identifiers that are associated with a “worried” emotional state. By way of example, such text sentiment identifiers may be generated based on text that includes a phrase that is indicative of one being worried (e.g., “I can't do anything”). Node 406B corresponds to one or more text sentiment identifiers that are associated with neutral emotional state. By way of example, such text sentiment identifiers may be generated based on text that includes a phrase that is indicative of a neutral emotional state (e.g., “I still need another six hours”). Node 406C corresponds to one or more text sentiment identifiers that are associated with a sad emotional state. By way of example, such text sentiment identifiers may be generated based on text that includes a first phrase that is indicative of a sad emotional state (e.g., “Last day working for the uni today, sad times”). Node 406D corresponds to one or more text sentiment identifiers that are associated with a sad emotional state. By way of example, such text sentiment identifiers such text sentiment identifiers may be generated based on text that includes a second phrase that is indicative of a sad emotional state (e.g., “There are back-to-back meetings, unable to clear”).

Node 408A corresponds to one or more voice sentiment identifiers that are associated with the “worried” emotional state. And node 408B corresponds to one or more voice sentiment identifiers that are associated with a “sad” emotional state.

FIG. 5A is a diagram illustrating the operation of the recommendation engine 218, according to one implementation. As illustrated, the recommendation engine 218 may receive information from the expert repository 222. The recommendation engine 208 may generate a composite signature of a user based on the information. The recommendation engine 208 may then classify the composite signature into one of categories 502A-506A. In the example of FIG. 5A, each of the categories 502A-C corresponds to a different engagement action that can be performed with respect to the user. Specifically, category 502A corresponds to monitoring the user; category 504A corresponds to scheduling a one-on-one meeting with the user; and category 506A corresponds to sending an email to the user. The classification may be performed by using a random forest classifier 508A. The random forest classifier 508A may use a large group of complex decision trees and provide classification predictions with a high degree of accuracy on any size of data. This random forest classifier 508A may output for each of the categories 502A-506A a likelihood percentage. In some implementations, when the random forest classifier 508A is evaluated based on a given composite signature, one of the categories 502A-506A which receives the highest likelihood percentage may be considered to be the category in which the composite signature is classified into. Although in the example of FIG. 5A the plurality of categories associated with the classifier 508A includes three categories, alternative implementations are possible in which the plurality of categories includes a larger or smaller number of categories. Furthermore, it will be understood that the present disclosure is not limited to any specific engagement action or set of engagement actions being associated with the plurality of categories.

The random forest classifier 508A may be trained based on a training data set 510A by using a supervised learning algorithm. The training data set 510A may be generated based on communications between users of the system 100 (and/or other users). The training data set may include a plurality of training data items. Each training data item may include a composite signature and a label. Depending on the implementations, the label may identify an engagement action that is appropriate for the composite signature. Any of the engagement actions that are identified by the labels may correspond to one of the categories 502A-506A. According to the present example, each of the labels is generated manually. Although in the example of FIG. 5A, the recommendation engine 218 uses a random forest classifier to classify composite signatures, alternative implementations are possible in which a neural network or another means for classification is used.

FIG. 5B is a diagram illustrating the operation of the recommendation engine 218, according to another implementation. As illustrated, the recommendation engine 218 may receive information from the expert repository 222. The recommendation engine 208 may generate a composite signature of a user based on the information. The recommendation engine 208 may then classify the composite signature into one of categories 502B-506B. In the example of FIG. 5B, each of the categories 502B-C corresponds to a different job-specific state, which the user can be in. Specifically, category 502B corresponds to an “enthusiastic” state; category 504B corresponds to a “disinterested” state; and category 506B corresponds to a “fatigued state”. The classification may be performed by using a random forest classifier 508B. The random forest classifier 508B may use a large group of complex decision trees and provide classification predictions with a high degree of accuracy on any size of data. This random forest classifier 508B may output for each of the categories 502B-506B a likelihood percentage. In some implementations, when the random forest classifier 508B is evaluated based on a given composite signature, one of the categories 502B-506B which receives the highest likelihood percentage may be considered to be the category in which the composite signature is classified into. Although in the example of FIG. 5B the plurality of categories associated with the classifier 508B includes three categories, alternative implementations are possible in which the plurality of categories includes a larger or smaller number of categories. Furthermore, it will be understood that the present disclosure is not limited to any specific job-specific state or job-specific states being associated with the plurality of categories. As used throughout the disclosure, the term “job-specific state” may refer to the disposition of a user at the job or towards the job. Examples of job-specific states include “enthusiastic towards the job”, “fatigued (or burnt-out) by the job”, “neutral towards the job”, disinterested with the job”, “happy with the job,” etc.

The random forest classifier 508B may be trained based on a training data set 510B by using a supervised learning algorithm. The training data set 510B may be generated based on communications between users of the system 100 (and/or other users). The training data set may include a plurality of training data items. Each training data item may include a composite signature and a label. Depending on the implementations, the label may identify a job-specific state that is appropriate for the composite signature. Any of the job-specific states that are identified by the labels may correspond to one of the categories 502B-506B. According to the present example, each of the labels is generated manually. Although in the example of FIG. 5B, the recommendation engine 218 uses a random forest classifier to classify composite signatures, alternative implementations are possible in which a neural network or another means for classification is used.

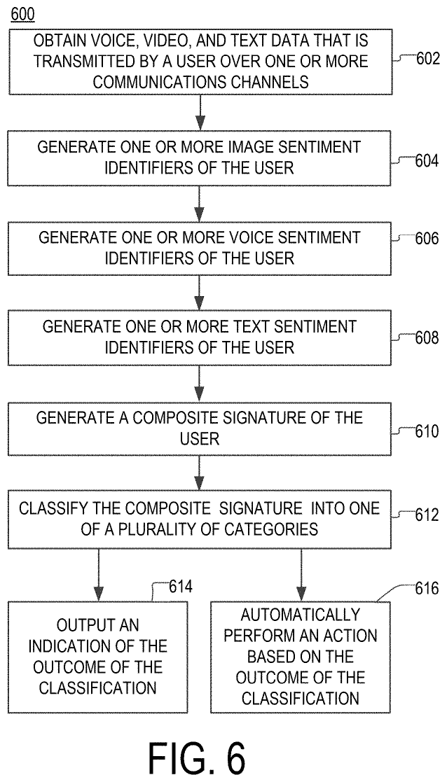

FIG. 6 is a flowchart of an example of a process 600, according to aspects of the disclosure. According to the example of FIG. 6, the process 600 is performed by the employee monitoring system 104. However, it will be understood that the present disclosure is not limited to any specific entity performing the process 600.

At step 602, the system 104 obtains voice, video, and text data that is transmitted by one of the users of the system 100 (e.g., the users of any of devices 102, which are shown in FIG. 1). As noted above, the obtained data may include one or more of a transcript of a telephone call in which the user participated, a video recording of the telephone call, a message transcript of the user, the text of one or more emails that were authored by the user, and/or any other suitable type of data that is transmitted by the user over one or more communications channels, such as a telephony channel, online chat, SMS, email, etc.

At step 604, the system 104 generates one or more image sentiment identifiers of the user based on at least some of the data (obtained at step 602). In some implementations, any of the image sentiment identifiers may be generated by using the neural network 213 (shown in FIG. 2). In some implementations, any of the image sentiment identifiers may be generated in the manner discussed above with respect to FIG. 2.

At step 606, the system 104 generates one or more voice sentiment identifiers of the user based on at least some of the data (obtained at step 602). In some implementations, any of the voice sentiment identifiers may be generated by using the neural network 215 (shown in FIG. 2). In some implementations, any of the voice sentiment identifiers may be generated in the manner discussed above with respect to FIG. 2.

At step 608, the system 104 generates one or more text sentiment identifiers of the user based on at least some of the data (obtained at step 602). In some implementations, any of the text sentiment identifiers may be generated by using the neural network 217 (shown in FIG. 2). In some implementations, any of the text sentiment identifiers may be generated in the manner discussed above with respect to FIG. 2.

At step 610, the system 104 generates a composite signature based on the image, voice, and text sentiment identifiers that are generated at steps 604-608. The composite signature may be generated in the manner discussed above with respect to FIG. 2.

At step 612, the system 104 classifies the composite signature into one of a plurality of categories. According to the present disclosure, the composite signature is classified with a random forest classifier. However, it will be understood that the present disclosure is not limited to using any specific model for performing the classification. In some implementations, each of the plurality of categories may correspond to a different job-specific state (e.g., see FIG. 5B). Additionally or alternatively, in some implementations, each of the categories may correspond to a different engagement action (e.g., see FIG. 5A).

At step 614, the system 104 outputs an indication of the outcome of the classification (performed at step 612). For example, in some implementations, the system 104 may display (on a display device of the system 104) an indication of the engagement action, or a job-specific state, which corresponds to the category in which the composite signature has been classified. Additionally or alternatively, in some implementations, the system 104 may transmit (to a remote terminal) an indication of the engagement action, or job-specific state, which corresponds to the category in which the composite signature has been classified. Additionally or alternatively, in some implementations, the system 104 may store the indication in a non-volatile memory for later review.

At step 616, the system 104 automatically performs an action based on the outcome of the classification. In some implementations, when the composite signature is classified into a category corresponding to an engagement action, the system 104 may automatically perform the action or create a calendar appointment for performing the action. For instance, when the category in which the composite signature is classified is associated with the action of “begin monitoring the user”, the system 104 may automatically add an identifier of the user to a list of users who are being monitored or who need to be examined more closely by human resource personnel. As another example, when the category in which the composite signature is classified is associated with the action of “send an email”, the system 104 may automatically send the email. As yet another example, when the category in which the composite signature is classified is associated with the action of “conduct a one-on-one meeting with the user”, the system 104 may automatically create an invite for the meeting and send the invite to the user and/or another participant in the meeting (e.g., a human resource specialist).

FIGS. 1-6 are provided as an example only. In this regard, at least some of the steps discussed with respect to FIGS. 1-6 may be performed in a different order, in parallel, or altogether omitted. For example, one of steps 614 and 616 (shown in FIG. 6) may be omitted. As another example, at least some of the steps shown in FIG. 6 may be performed in parallel, in a different order, or altogether omitted. As used herein, the phrase “record of a communication” may refer to the communication itself. For example, “a record of an email” may include the text of the email. As another example, a record of an SMS message may include the text of the SMS message, etc. Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid-state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required.*. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method comprising:
generating first sentiment identifier of a user, the first sentiment identifier of the user being a text sentiment identifier, the text sentiment identifier being indicative of an emotional state that is manifested in one or more of a telephone call in which the user participated, an email that is authored by the user, and/or a message exchange in which the user participated;
generating a second sentiment identifier of the user, the second sentiment identifier including one of a voice sentiment identifier of the user and an image sentiment identifier of the user, the image sentiment identifier being an indication of an emotional state of the user that is manifested in a facial expression of the user during the telephone call, the voice sentiment identifier being an indication of an emotional state of the user that is manifested in a tone of voice of the user during the telephone call;
generating a composite signature of the user based on the first sentiment identifier and the second sentiment identifier; and
classifying the composite signature of the user into one of a plurality of categories, each of the plurality of categories being associated with at least one of: (i) different levels of workplace fatigue and/or (ii) different actions for reducing workplace fatigue.

2. The method of claim 1, wherein each of the plurality of categories is associated with a different action for reducing workplace fatigue.

3. The method of claim 1, wherein each of the plurality of categories is associated with a different level of workplace fatigue.

4. The method of claim 1, further comprising generating a third sentiment identifier of the user, the third sentiment identifier including the other one of the voice sentiment identifier and the image sentiment identifier, wherein the composite signature is generated further based on the third sentiment identifier of the user.

5. The method of claim 1, wherein the second sentiment identifier includes the voice sentiment identifier.

6. The method of claim 1, wherein the second sentiment identifier includes an image sentiment identifier.

7. The method of claim 1, further comprising outputting an indication of an outcome of the classification of the composite signature.

8. The method of claim 1, further comprising automatically performing an action based on an outcome of the classification of the composite signature.

9. A system, comprising:
a memory; and
at least one processor operatively coupled to the memory, the at least one processor being configured to perform the operations of:
generating first sentiment identifier of a user, the first sentiment identifier of the user being a text sentiment identifier, the text sentiment identifier being indicative of an emotional state that is manifested in one or more of a telephone call in which the user participated, an email that is authored by the user, and/or a message exchange in which the user participated;
generating a second sentiment identifier of the user, the second sentiment identifier including one of a voice sentiment identifier of the user and an image sentiment identifier of the user, the image sentiment identifier being an indication of an emotional state of the user that is manifested in a facial expression of the user during the telephone call, the voice sentiment identifier being an indication of an emotional state of the user that is manifested in a tone of voice of the user during the telephone call;
generating a composite signature of the user based on the first sentiment identifier and the second sentiment identifier; and
classifying the composite signature of the user into one of a plurality of categories, each of the plurality of categories being associated with at least one of: (i) different levels of workplace fatigue and/or (ii) different actions for reducing workplace fatigue.

10. The system of claim 9, wherein each of the plurality of categories is associated with a different action for reducing workplace fatigue.

11. The system of claim 9, wherein each of the plurality of categories is associated with a different level of workplace fatigue.

12. The system of claim 9, wherein the at least one processor is further configured to perform the operation of generating a third sentiment identifier of the user, the third sentiment identifier including the other one of the voice sentiment identifier and the image sentiment identifier, wherein the composite signature is generated further based on the third sentiment identifier of the user.

13. The system of claim 9, wherein the second sentiment identifier includes the voice sentiment identifier.

14. The system of claim 9, wherein the second sentiment identifier includes an image sentiment identifier.

15. The system of claim 9, wherein the at least one processor is further configured to perform the operation of outputting an indication of an outcome of the classification of the composite signature.

16. The system of claim 9, wherein the at least one processor is further configured to perform the operation of automatically performing an action based on an outcome of the classification of the composite signature.

17. A non-transitory computer-readable medium storing one or more processor-executable instructions, which, when executed by at least one processor, cause the at least one processor to perform the operations of:
generating first sentiment identifier of a user, the first sentiment identifier of the user being a text sentiment identifier, the text sentiment identifier being indicative of an emotional state that is manifested in one or more of a telephone call in which the user participated, an email that is authored by the user, and/or a message exchange in which the user participated;
generating a second sentiment identifier of the user, the second sentiment identifier including one of a voice sentiment identifier of the user and an image sentiment identifier of the user, the image sentiment identifier being an indication of an emotional state of the user that is manifested in a facial expression of the user during the telephone call, the voice sentiment identifier being an indication of an emotional state of the user that is manifested in a tone of voice of the user during the telephone call;
generating a composite signature of the user based on the first sentiment identifier and the second sentiment identifier; and
classifying the composite signature of the user into one of a plurality of categories, each of the plurality of categories being associated with at least one of: (i) different levels of workplace fatigue and/or (ii) different actions for reducing workplace fatigue.

18. The non-transitory computer-readable medium of claim 17, wherein each of the plurality of categories is associated with a different action for reducing workplace fatigue.

19. The non-transitory computer-readable medium of claim 17, wherein each of the plurality of categories is associated with a different level of workplace fatigue.

20. The non-transitory computer-readable medium of claim 17, wherein the one or more processor-executable instructions, when executed by the at least one processor, further cause the at least one processor to perform the operation of generating a third sentiment identifier of the user, the third sentiment identifier including the other one of the voice sentiment identifier and the image sentiment identifier, wherein the composite signature is generated further based on the third sentiment identifier of the user.
